(19) United States
(12) Patent Application Publication
(10) Pub. No.: US 2016/0063162 A1
(43) Pub. Date: Mar. 3, 2016

(54) SYSTEM AND METHOD USING PASS/FAIL TEST RESULTS TO PRIORITIZE ELECTRONIC DESIGN VERIFICATION REVIEW

(71) Applicant: Synopsys, Inc., Mountain View, CA (US)

(72) Inventors: Yuan Lu, Saratoga, CA (US); Yong Liu, Cupertino, CA (US); Jian Yang, San Jose, CA (US)

(73) Assignee: Synopsys, Inc., Mountain View, CA (US)

(21) Appl. No.: 14/812,109

(22) Filed: Jul. 29, 2015

Related U.S. Application Data
(60) Provisional application No. 62/041,661, filed on Aug. 26, 2014.

(51) Int. Cl. G06F 17/50

(52) U.S. Cl. CPC G06F 17/5045; G06F 17/5009

(57) ABSTRACT

A system and method are provided that use pass/fail test results to prioritize electronic design verification review issues. It may prioritize either generated properties or code coverage items or both. Thus issues, whether generated properties or code coverage items, that have never been violated in any passing or failing test may be given highest priority for review, while those that have been violated in a failing test but are always valid in passing tests may be given lower priority. Still further, where end-users have marked one or more properties or code coverage items as already-reviewed, the method will give these already-reviewed issues the lowest priority. As a result, both properties and code coverage items may be generated together in a progressive manner starting earlier in development and significant duplication of effort is avoided.

### CROSS-REFERENCE TO RELATED APPLICATION

This application claims priority under 35 U.S.C. 119(e) from prior U.S. provisional application 62/041,661, filed Aug. 26, 2014.

### TECHNICAL FIELD

The invention relates to integrated circuits verificatin, e.g. by means of simulation, and more particularly to systems, methods and computer program products for prioritizing electronic design verification review issues.

### BACKGROUND ART

Electronic chip designers continue to develop electronic chips of ever increasing complexity using more and more transistors. Verifying the behavior of an electronic chip has becoming increasingly difficult and time-consuming. A considerable amount of engineering time is spent running and analyzing simulation results.

Design verification teams spend many months developing, running and analyzing simulation tests and their results. The verification teams typically first develop functional tests, also known as directed tests. These functional tests are designed to test expected behavior as described in a functional specification. The functional tests check that the design works in all modes and configurations. When the verification teams first run the functional tests they typically show errors in the design and errors in the test. After some period of time, after correcting the design and test errors, the design and verification teams will agree one or more regression test suites. The verification teams will run daily and weekly regression tests.

After functional test verification, the verification team will typically start random testing. Random tests typically check scenarios with different sets of pseudo-random test inputs. Random testing usually shows fewer errors than functional testing.

After random testing, the verification team typically starts code coverage analysis. They want to ensure that all lines of RTL code are exercised. Verification teams typically use simulators to generate code coverage reports using the previously developed tests for data input. They analyze these reports and try to ensure all lines of RTL code are exercised. The verification teams often find “dead-code”, code that isn't needed, and they find situations that the functional tests didn't test but should have tested. The code coverage project phase generally finds few design errors but is considered a necessary step. The code coverage reports provide a large volume of detailed information. Verification teams and design engineers find it time-consuming and tedious to review the code coverage issues.

Electronic design automation (EDA) tools are making increased use of verification properties to augment simulation and reduce the verification cost. A verification property declares a condition in the design. If a property always holds true, we call them an assertion. For example, a property “overflow==1′b0” should always hold for any correct FIFO design. On the other hand, a property can capture possible behavior allowed by the design; we call such a property a cover property. For example, a property “full==1′b1” can be a typical coverage property on the same FIFO design. For the given above two examples, we typically write them as:
assert overflow==1′b0
cover full==1′b1

Users can specify verification properties in an RTL file or in a separate constraint file. They are typically written in specific language including System Verilog Assertions (SVA) or Property Specification Language (PSL). Many EDA tools can parse/generate verification properties. Some EDA tools can generate verification properties by analyzing RTL statements. Other EDA tools can generate verification properties by analyzing simulation test results.

Atrenta Inc.'s Bugscope® EDA tool has proven valuable in finding test coverage holes. Bugscope® generates verification properties by analyzing simulation, test results. For example it may note that in one test the condition “full==1′b0” is always true. If Bugscope® discovers that the same condition is false in a second test it treats the condition as a coverage property and generates the property “cover full==1′b1”. The coverage property condition is inverted with respect to the discovered property to direct a simulator to check for the inverted condition. We say that the second test covers the property. Bugscope® may note that the condition “overflow==1′b0” is always true in all tests. In this case it cannot tell if the property is a coverage property or an assertion.

Using verification properties places an additional review burden on the verification engineer. In addition to reviewing code coverage data the verification team must also review generated properties and simulation property results.

Verification teams would prefer EDA tools that simplify the task of reviewing code coverage and generated property results. Design and verification teams would like to speed up the overall development schedule by reducing time spent reviewing coverage items and get coverage information earlier in the development schedule.

### SUMMARY DISCLOSURE

A system and method are provided that use pass/fail test results to prioritize electronic design verification review issues. It may prioritize either generated properties or code coverage items or both. Thus issues, whether generated properties or code coverage items, that have never been violated in any passing or failing test may be given highest priority for review, while those that have been violated in a failing test but are always valid in passing tests may be given lower priority. Still further, where end-users have marked one or more properties or code coverage items as already-reviewed, the method will give these already-reviewed issues the lowest priority.

As a result, both properties and code coverage items may be generated together in a progressive manner starting earlier in development. Properties for unchanged modules that have already been verified from a previous version of a chip can be removed or given lowest priority to avoid duplication of effort. Likewise, properties and code coverage items that are only violated at failing tests may be removed or given lower priority so that repetitive testing of such issues at every design regression can be minimized or avoided altogether. The number of issues to review is therefore significantly smaller than the old approach.

### BRIEF DESCRIPTION OF THE DRAWINGS

FIG. 1 shows a simulation test process.

FIG. 2 shows an example table of property results on different tests.

FIG. 3 shows a flowchart, in accord with the present invention, outlining the steps for prioritizing review properties.

FIG. 4 shows a block diagram of a Verification Issue Rating System in accord with the present invention.

### DETAILED DESCRIPTION

A Verification Issue Rating System (VIRS) in accord with the present invention uses pass/fail test results to prioritize electronic design verification review issues. Properties that have never been violated in any passing or failing test are given highest priority. Properties that have been violated in a failing test are given lower priority. Similarly, code coverage items that have never been exercised in any passing or failing test are given highest priority. Code coverage items that have been exercised in a failing test are given lower priority.

Verification teams typically use simulators to generate code coverage reports to discover which lines of RTL design code have not been exercised. For example, an RTL design may include a case statement specifying four conditions corresponding to the four combinations of values for a pair of binary signals. The code coverage report may report that cases 00, 01 and 10 are exercised but the case 11 is not exercised. The RTL code for case 11 is flagged for engineering review.

EDA tools like Bugscope® generate properties by analyzing a design and its test simulation results. Verification engineers review the generated properties looking for test coverage holes and design errors. The generated properties may indicate a relationship that should always be true, called an assertion. The generated property may indicate a situation that hasn't been tested, called a coverage property. The generated property may also indicate a design error. Coverage properties that are true in all tests indicate a test coverage hole. Verification engineers are more interested in these types of coverage properties than in assertions. A coverage property may indicate that the verification team needs to generate a new test.

During the early stages of development it is common to see test failures and assertion property violations. These assertion property violations are often the result of design errors. For example, a verification engineer may know that a FIFO should not overflow. The verification engineer creates functional tests trying to create a FIFO overflow and may manage to show conditions under which FIFO overflow can occur. After a design engineer corrects the design the test passes and the assertion properties pass. Tests that failed previously and now work give a strong indication that the failing properties were assertion properties and not coverage properties. To take advantage of this information the EDA tools need to maintain a database of test results over time.

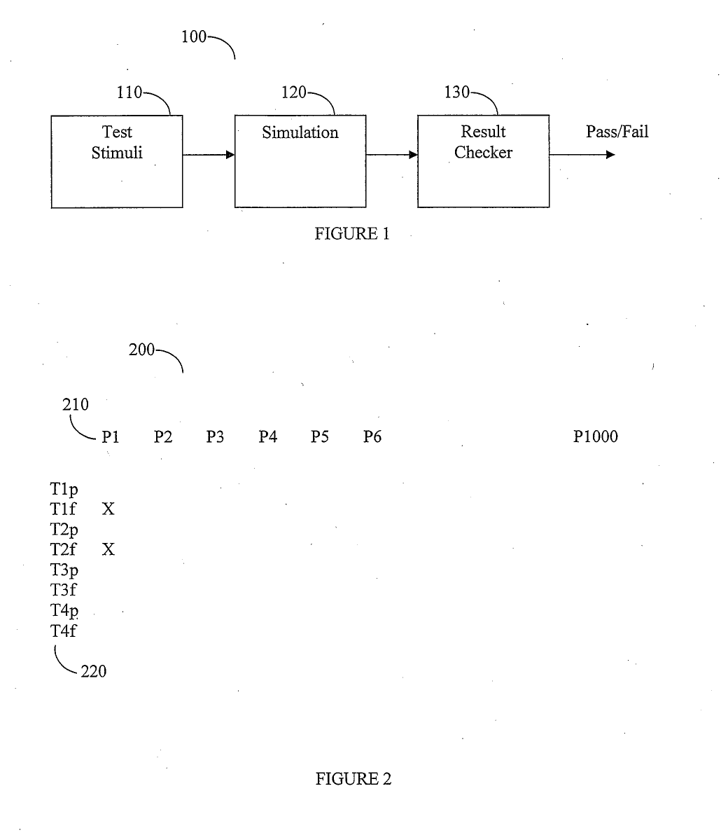

FIG. 1 shows a diagram 100 that illustrates the test process. The design engineer creates test stimuli 110 that define waveform signal inputs. The simulator 120 simulates the design using test stimuli 110 and creates results that are fed into a result checker 130. The result checker 130 checks the results and decides if the test passes or fails. In some cases the result checker will have a file of expected results that it compares to the actual results. In other cases the checker will utilize an independent model of expected behavior, generate expected results and compare them to the simulation results. The engineering team may have made mistakes in the result checker 130, in the design being simulated in simulator 120, or in the test stimuli 110.

In the case of a result checker error, the design behavior observed in the failure test is legal but the result checker thinks it is illegal. Assume that there is a property P which gets violated in this failure test. Given that it is a checker failure, the verification engineer will fix the result checker while the stimulus will be kept the same. When the result checker is fixed, you will see that this property P still gets violated. The VIRS will ignore this property P because it cannot be an assertion and it isn't a coverage property that is true for all tests.

In the case of a design error, assume that a property P is violated. When the design is fixed, testing P can have only two consequences: a) P holds true; b) P is still incorrect. For case a), P is very likely to be an assertion because it is violated in a failure test and once it is fixed, it holds. For case b), P must be a coverage property. This implies that the failure test exercises a previously uncovered corner case, and therefore finds a bug. When the design is fixed, the test still exercises this corner case, and that is why this P is still violated. In this way, we find with high probability that a property is an assertion. The VIRS uses this information to prioritize both generated properties as well as code coverage.

In the case of a test stimulus error, the analysis is very similar to that of the design error. The only difference is that the verification engineer has to fix test stimuli instead of the design. Testing the violated property P will still have two consequences: a) P holds true; b) P is still incorrect. For case a), P is very likely to be an assertion. For case b), P must be a coverage property.

FIG. 2 shows an example table 200 showing property failures in passing and failing tests. The column heading 210 shows the names of the properties, P1, P2 . . . P1000. The row heading 220 shows the names of the tests and for each test for a passing row and a failing row. In this example property P1 is violated in failing tests T1f and T2f. The VIRS only considers properties that are true in all passing tests. The VIRS gives high review priorities to those properties that are true in all passing and failing tests. The VIRS gives lower review priorities to those properties are true in all passing tests but have been violated in failing tests. In this example property P1 has low review priority and the other properties have high review priority.

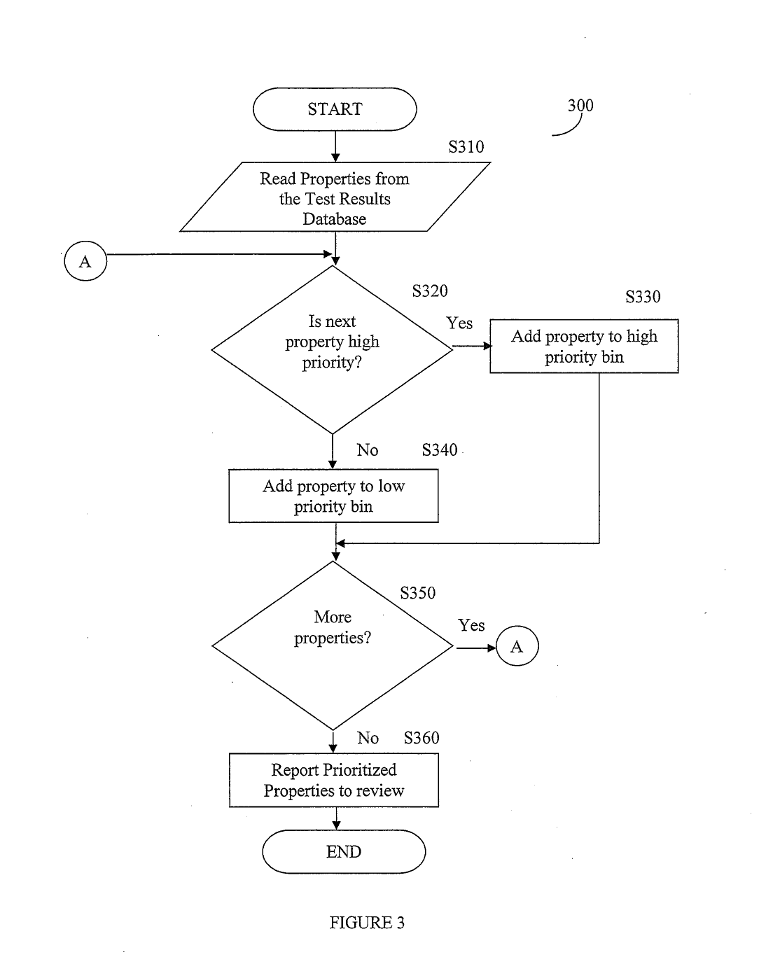

FIG. 3 is an exemplary and non-limiting flowchart 300 for prioritizing electronic design verification property issues. The same approach applies to code coverage issues. In S310 the VIRS reads the Test Results Database and creates a list of properties that are true in all passing tests. In S320 the VIRS starts a loop that processes the properties identified in S310. The first time the VIRS executes S320 the VIRS selects the first property. On subsequent iterations the VIRS processes the next property. In S320 the VIRS decides if the selected property has high review priority. The VIRS assigns high priority if the property is true in all passing and failing tests. If the VIRS decides the property has high review priority the VIRS proceeds to S330. If the VIRS decides the property does not have high review priority the VIRS proceeds to S340. At S330 the VIRS adds the selected property to a list of high priority review items and proceeds to S350. At S340 the VIRS adds the selected property to a list of low priority review items and proceeds to S350. At S350 the VIRS decides if it has finished processing all properties in the list identified in S310. If the VIRS has more properties to process the VIRS it proceeds to S320. If the VIRS has no more properties to process the VIRS it proceeds to S360. In S360 the VIRS reports high and low priority review items using the lists it constructed at S330 and S340. In one embodiment the VRS stores the high and low priority review items in a report file.

The VIRS handles code coverage review items in a similar manner to the way it handles properties. In S310 the VIRS would list code coverage items instead of properties. In S320 the VIRS would give high priority to code coverage items that aren't covered in any passing or failing test. Subsequent steps would apply to code coverage items.

In one embodiment the VIRS allows users to mark verification items as “already reviewed”. The VIRS takes account of the user's “already reviewed” designation when prioritizing review items. In one embodiment the VIRS creates 4 categories of review items: a) high review priority and not “already reviewed”; b) high review priority and “already reviewed”; c) low review priority and not “already reviewed”; and d) low review priority and “already reviewed”.

The embodiments disclosed herein can be implemented as hardware, firmware, software, or any combination thereof. Moreover, the software is preferably implemented as an application program tangibly embodied on a program storage unit or computer readable medium. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

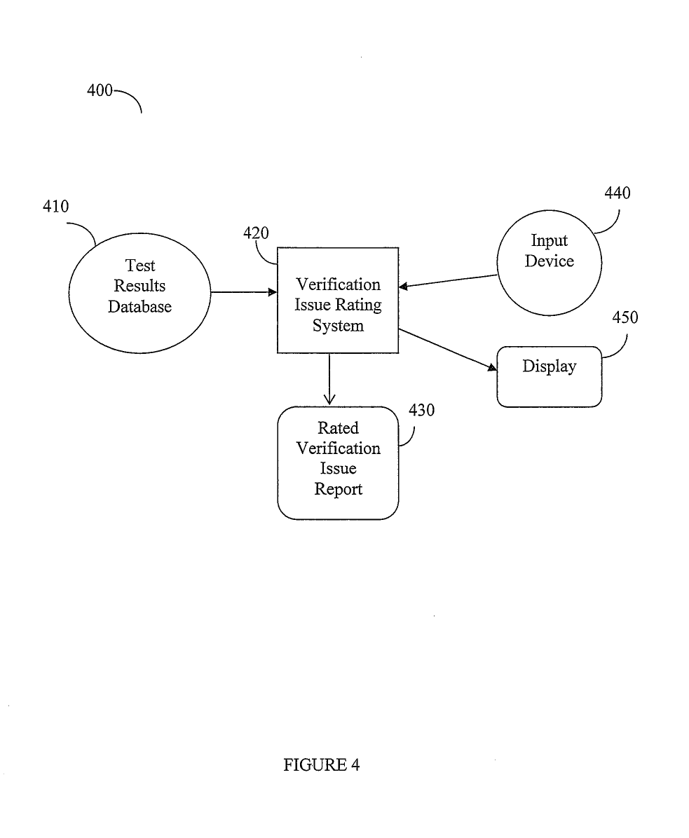

FIG. 4 is an exemplary and non-limiting diagram 400 showing a Verification Issue Rating System (VIRS) 420 in accord with the present invention. The VIRS 420 runs as an application program on a central processing unit (CPU). The VIRS 420 interacts with a user through an input device, 440 and a display, 450. Using the input device 440 the user starts the VIRS 420 execution and specifies VIRS 420 inputs. In one embodiment the VIRS 420 displays the prioritized issues in the form of a Rated Verification Issue Report 430 on the display 450. The VIRS 420 reads verification issues from a Test Results Database 410. The VIRS 420 uses the pass/fail history in the Test Results Database 410 to generate prioritized issues. In one embodiment the VIRS is encapsulated as an application within an EDA tool-chain. In another embodiment the VIRS is encapsulated as a software module within another EDA application program.

What is claimed is:

1. A method implemented as a verification issue rating tool in a computing system for prioritizing verification review issues as part of a verification of the design of an integrated circuit, the method comprising:
receiving a register-transfer-level (RTL) description of a design for an integrated circuit and storing the received description in a memory;
receiving simulation test results corresponding to the received RTL description of the integrated circuit in a test results database;
obtaining properties for each simulation test, each property having a pass/fail result for at least one simulation among the received simulation test results, each simulation test also assigned a pass/fail result for the test;
categorizing for each property a priority level based on its pass/fail results and storing at least an identification of that categorized property in a computer readable file corresponding to its priority level; and
displaying on a computer display information from the computer readable file corresponding to at least a highest priority level.

2. The method as in claim 1, wherein at least some of the properties are received by the computing system from an input device thereof.

3. The method as in claim 1, wherein at least some of the properties are generated by the computing system, from the received simulation test results.

4. The method as in claim 1, wherein any property whose pass/fail results indicate that the property has never failed a simulation test are given a highest priority level.

5. The method as in claim 4, wherein any property whose pass/fail results indicate that the property has only failed in one or more simulation tests that have themselves failed are given a lower priority level.

6. The method as in claim 5, wherein any property whose pass/fail results indicate the property has always failed being categorized as assertions and given a lowest priority level.

7. The method as in claim 1, further comprising:
generating and storing code coverage items for each simulation test indicating conditions for each property that have or have not been exercised by that test;
categorizing for each code coverage item a code coverage priority level based on whether a condition has been exercised in any of the simulation tests and storing at least an identification of that categorized code coverage item in a computer readable file corresponding to its priority level; and
displaying on a computer display information from the computer readable file corresponding to at least a highest priority level of code coverage items.

8. The method as in claim 7, wherein any code coverage item for which a condition has never been exercised in any simulation test is given a highest priority level.

9. The method as in claim 8, wherein any code coverage item for which a condition has only been exercised in a failing simulation test is given a lower priority level.

10. The method as in claim 9, wherein any code coverage item for which a condition has been exercised in a passing simulation test is categorized as a fully covered item and given a lowest priority level.

11. The method as in claim 1, further comprising receiving user input marking any one or more properties as already reviewed, wherein the categorizing of each generated property assigns those properties marked as already reviewed to priority levels that are distinct from those for properties not so marked.

12. The method as in claim 7, further comprising receiving user input marking any one or more code coverage items as already reviewed, wherein the categorizing of each code coverage item assigns those code coverage items marked as already reviewed to priority levels that are distinct from those for code coverage items not so marked.

13. A verification issue rating system for prioritizing verification review issues as part of a verification of the design of an integrated circuit, the system comprising:
a processing unit;
at least one memory accessible to the processing unit for receiving and storing (a) a program for implementing the rating system, (b) a register-transfer-level (RTL) description of a design for an integrated circuit, (c) a test results database containing simulation test results corresponding to the RTL description, each simulation test being assigned a pass/fail result for the test; (d) properties for each simulation test, each property having a pass/fail result for at least one simulation among the simulation test results in the database; and (e) computer readable files corresponding to priority levels, each file storing at least an identification of a property categorized by the processing unit as belonging to that file's priority level; and
a display,
wherein the processing unit executing the program accesses the test results database, categorizes for each property a priority level based on its pass/fail results, stores at least an identification of that categorized property in a computer readable file corresponding to its priority level, and displays on the computer display information from the computer readable file corresponding to at least a highest priority level.

14. The system as in claim 13, wherein at least some of the properties are received by the memory from an input device of the system.

15. The system as in claim 13, wherein at least some of the properties are generated by the processing unit from the stored simulation test results.

16. The system as in claim 13, wherein any generated property whose pass/fail results indicate that the property has never failed a simulation test are given a highest priority level.

17. The system as in claim 16, wherein any generated property whose pass/fail results indicate that the property has only failed in one or more simulation tests that have themselves failed are given a lower priority level.

18. The system as in claim 17, wherein any generated property whose pass/fail results indicate the property has always failed being categorized as assertions and given a lowest priority level.

19. The system as in claim 13, wherein the at least one memory further stores (f) code coverage items for each simulation test indicating conditions for each property that have or have not been exercised by that test, and (g) computer readable files corresponding to respective priority levels for code coverage items,
wherein the processing unit executing the program (1) categorizes, for each code coverage item, a code coverage priority level based on whether a condition has been exercised in any of the simulation tests, storing at least an identification of that categorized code coverage item in a computer readable file corresponding to its priority level, and (2) displays on the computer display information from the computer readable file corresponding to at least a highest priority level of code coverage items.

20. The system as in claim 19, wherein any code coverage item for which a condition has never been exercised in any simulation test is given a highest priority level.

21. The system as in claim 20, wherein any code coverage item for which a condition has only been exercised in a failing simulation test is given a lower priority level.

22. The system as in claim 21, wherein any code coverage item for which a condition has been exercised in a passing simulation test is categorized as a fully covered item and given a lowest priority level.

23. The system as in claim 13, further comprising
a user input device for receiving user input marking any one or more properties as already reviewed,
wherein the categorizing of each generated property assigns those properties marked as already reviewed to priority levels that are distinct from those for properties not so marked.

24. The system as in claim 19, further comprising:
a user input device for receiving user input marking any one or more properties as already reviewed,
wherein the categorizing of each code coverage item assigns those code coverage items marked as already reviewed to priority levels that are distinct from those for code coverage items not so marked.
